(19) United States
(12) Patent Application Publication
(10) Pub. No.: US 2002/0134709 A1
(43) Pub. Date: Sep. 26, 2002

(54) Woven screen mesh for filtering solid articles and method of producing same

(76) Inventor: Russell Allen Riddle, Chelsea, OK (US)

Correspondence Address: Mark G. Kachigian, Head, Johnson & Kachigian, 228 West 17th Place, Tulsa, OK, 74119, US

(21) Appl. No.: 10/055,205

(22) Filed: Jan. 23, 2002

Related U.S. Application Data
(60) Provisional application No. 60/264,108, filed on Jan. 25, 2001.

(51) Int. Cl. B07B 1/46; B21F 27/02

(52) U.S. Cl. 209/238; 140/17; 29/896.62

(57) ABSTRACT

An improved wire cloth material and process to enhance wire cloth dimensional stability, reduce and slow abrasive, deterioration, decrease brittleness and reduce residual stress attendant to the manufacturing and weaving process. In a preferred embodiment, the wire cloth is subjected to a liquid cryogenic material for a determinable period of time which is sufficient to increase molecular bonding energy and achieve a structural balance by effecting the transformation of austenite to denser more refined martensite. The wire cloth is then withdrawn from the cryogenic material and allowed to warm gradually at a rate of controlled temperature change. To reduce brittleness of the martensitic structure following the warming phase, the wire cloth may be optionally introduced to a subsequent heat application phase in two or more passes and allowed to again gradually return to ambient atmospheric temperature.

### CROSS-REFERENCE OF RELATED APPLICATION

This application claims priority to U.S. Provisional Patent Application No. 60/264,108 filed Jan. 25, 2001, entitled WOVEN SCREEN MESH FOR FILTERING SOLID ARTICLES AND METHOD OF PRODUCING SAME.

### BACKGROUND OF THE INVENTION

1. Field of the Invention

The present invention is directed to an improved woven wire screen cloth with structured openings for filtering solid particles. In particular, the present invention is directed to a woven wire screen cloth having square or rectangular openings for filtering solid particles which have been subjected to cryogenic tempering to maximize screen cloth life.

2. Prior Art

The process of drilling for the exploration of crude oil and natural gas generates drill cuttings and ground solids. These cuttings and solids must be evacuated from the drill zone to progress with the drilling process. This is accomplished by introducing a drilling fluid, or “mud” as it is commonly called, from the surface down the drill stem forcing the fluid to flow up the well bore carrying the drill cuttings.

The mud has many functions; such as a lubricant, as coolant for the bit, as formation pressure stabilizer, as well as a hydraulic carrier for transporting the drill cuttings to the surface. In order to reclaim the mud, the solids are usually removed using a vibratory screening machine with a filtering media of wire cloth of appropriate size openings.

During the drilling process, the solids laden mud is directed over the screening area and due to the vibratory motion of the shaker, particles larger than the aperture size of the screen are separated from the mud and are conveyed on and down the length of the screen. The solids are discharged at the end of the shaker and the filtered mud is re-circulated down-hole to be used again. This is a very violent and abrasive process on the wire cloth.

The separation characteristics of the screening panel are relatively consistent as long as the integrity of the panel is intact. The screens generally fail in one of three ways: fatigue, solids abrasion and inter-cloth abrasion. Fatigue occurs when the screen is loaded to an extent that the wire cloth deflects significantly under load. The cyclic nature of the load causes the individual wires to break through fatigue and the cloth tends to rip.

Solids abrasion is fairly self-explanatory in that the solids will abrade the wire cloth and eventually the wires will wear and break. Inter-cloth abrasion is a phenomenon that occurs when multiple layers of wire cloth are used for the screen. In operation the layers rub against each other and will cause wear to each other, generally the finest layer fails first.

The term “wire cloth” as used herein is referred to synonymously as “wire mesh”, “wire cloth mesh”, and “screen cloth”. Such cloth relies heavily upon maintaining size consistency with respect to openings between inter-woven shute and warp filaments. As can be readily appreciated the intersecting or interweaving of these fibers introduces stress, particularly at the point(s) of intersection. The wire strands during the weaving process are slightly damages so that dents appear in the individual strands at each of the intersection points. There is thus, strain that is put on the individual wire strands during the weaving process. These are potential failure points to which the teachings of the present invention may be utilized.

In cloth fabrication scenarios where crimping of shute or warp fibers is present to enhance fiber positioning, additional stress is introduced to the fibers. In screen applications, particularly those applications where cloth material is exposed to continuous vibration combined with solids striking the material screen cloth, screen life is further reduced.

Wire cloth can be manufactured from various metals or alloys that can be drawn into wire suitable for weaving. Wire cloth weaving materials are typically, but not limitedly, comprised of the following materials: brass, copper, Inconel, Monel, nickel, Nichrome, stainless steel and carbon steel.

The following study is indicative of cryogenically treated wire cloth versus non-cryogenically treated wire cloth failure:

Trial Description

Two meshes were tested. One was 230 TBC (tensile bolting cloth) with 230 wires per inch in each direction. The wire diameter was approximately 0.0014 inch. The other was the same mesh from the same original lot which has been cryogenically treated. The meshes were both installed on the same machine described below as a vibrating shaker which employs two screen assemblies (left and right).

Screen Data:

| | | | | | | |
|---|---|---|---|---|---|---|
| | Mesh | Back | Middle | | | |
| Screen | Config. | Mesh | Mesh | Top Mesh | Shaker | Position |

| | | | |
|---|---|---|---|
| 121699-Cryo | 230# | #1 | Left |
| 121700 | 230# | #1 | Right |

Comments

The non-cryogenically treated cloth ripped during the manufacturing process of the screen assembly. Two screens were able to be salvaged. No such problems occurred with the cryogenic treated cloth.

Results:

| Time | Hours | 0 | 7 | 10 | 13 | 16 |
|---|---|---|---|---|---|---|
| 121699-Cryo | No. Failures | 0 | 0 | 8 | 7 | 3 |
| | Cumulative | 0 | 0 | 8 | 15 | 18 |
| 121700 | No. Failures | 0 | 2 | 23 | 8 | 5 |
| | Cumulative | 0 | 2 | 25 | 33 | 38 |

As can be seen from the chart and the foregoing, after 7 hours of use, the cryogenically treated cloth had significantly less failures.

It is, therefore, a goal of the present invention to balance enhanced screen life while maximizing the conductance of the screen at a reasonable cost of manufacture.

It is yet another object of the subject invention to provide for a process for the treatment of screen mesh wire cloth that is particularly adapted to provide such wire cloth with improved dimensional stability, hardness, longevity, and stability.

It is yet another object of the present invention to provide a woven screen mesh for filtering solid particles having stress relieved intersecting junctures of shute and warp filaments.

Another object of the present invention is to result in a wire mesh structure with a contact surface that increases wear resistance.

An object of the present invention is to provide for a wire cloth material with increased tensile strength, toughness and stability.

It is yet another object of the present invention to release the internal residual stress manifested as a result of wire mesh fabrication.

Other objects and further scope of the applicability of the present invention will become apparent from the detailed description to follow, taken in conjunction with the accompanying drawings wherein like parts are designated by like reference numerals.

### SUMMARY OF THE INVENTION

The present invention provides for an improved woven screen mesh for filtering solid particles. Such improvement is afforded by taking advantage of cryogenic strengthening of said mesh material. Mesh material constructions includes but not limited to pre-crimped wire cloth weave styles of double weave, scalping weave, double lock crimp, flat-top, triple shoot and intermediate crimp as well as common wire cloth weave styles including, but not limited to, plain weave, twill weave, Hollander (Dutch) weave, Hollander twill weave, and reverse Hollander. Woven screen mesh constituting the above and other weave constructions are introduced into a cryogenic chamber where a liquid cryogenic material cools the mesh at a controlled prescribed rate with a controlled temperature permeating the screen mesh. The temperature of the mesh is thereby brought down to a desired temperature. As the mesh material cools, movement of molecules in the metal structure slow and demonstrate their natural tendency to bond together during the second phase of cryogenic treatment.

The second phase of the cryogenic treatment begins when the mesh has cooled to or below −320° F. The phase lasts 24 to 48 hours and will vary according to the type of metal constituting the wire mesh material. This second phase lasts long enough to increase bonding energy and achieve a structured molecular balance throughout the wire mesh. Further changes are noted during the cryogenic phase which include the formation of additional micro fine-carbide fillers which tend to occupy remaining microvoid spaces in the mesh material. As an optional step, following cryogenic treatment for an appropriate period of time, the wire mesh is restored to room temperature gradually with precise control of temperature modification.

An optional, additional phase refers to a heat application phase wherein the newly derived martensitic structure can be heated multiple times from a room temperature to approximately 300° F. for an hour or more to minimize or eliminate brittleness. Following such repeated warming phases, the wire mesh is slowly restored to room temperature with brittleness thus relieved, reduced or eliminated.

### BRIEF DESCRIPTION OF THE DRAWINGS

FIG. 1 is a top view example of a typical woven screen mesh constructed in accordance with the present invention; and

FIG. 2 is a process step flow diagram illustrating the cryogenic treatment of woven wire mesh material in accordance with the present invention.

### DETAILED DESCRIPTION OF THE PREFERRED EMBODIMENTS

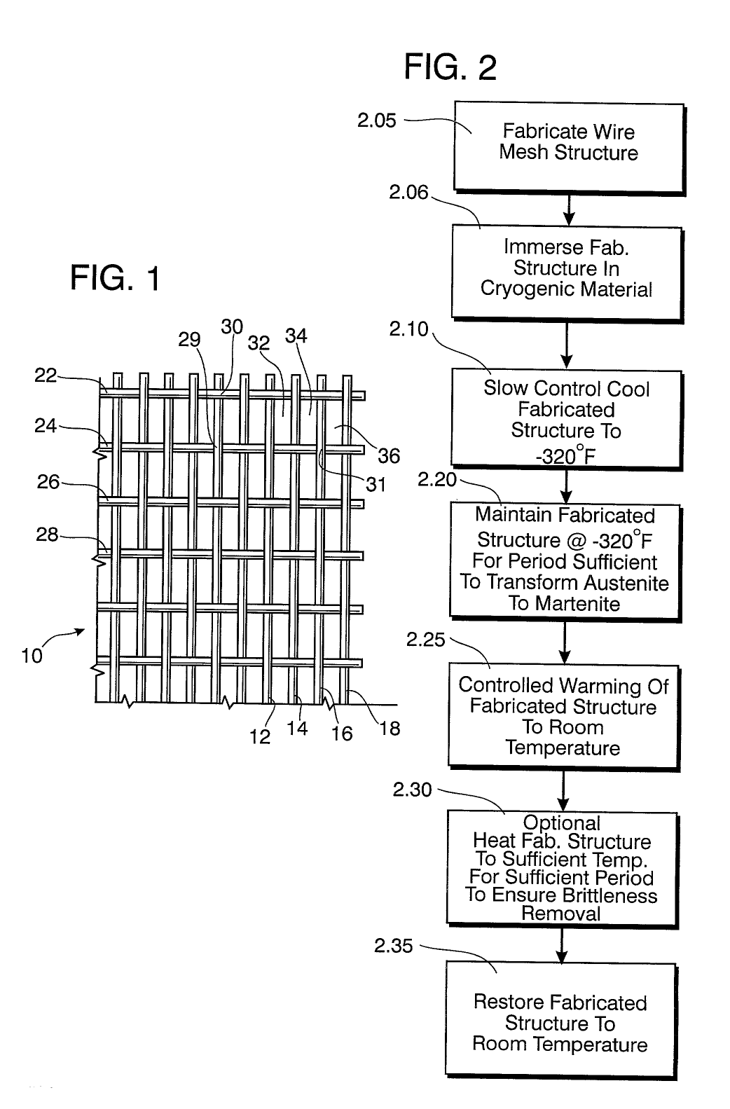

Referring to the drawings in detail, FIG. 1 illustrates a top view example of a typical woven screen mesh in accordance with the present invention. As can be seen in FIG. 1, warp filaments 12, 14, 16 and 18 and shute filaments 22, 24, 26 and 28 are woven and form a plurality of intersections 29, 30, 31, which, in turn, form rectangular openings, such as openings 32, 34 and 36.

Weaving such warp and shute fibers induces stress wherever such fibers intersect. In those instances where certain wire mesh designs call for crimping of said warp and/or shute fibers prior to weaving or following the weaving process to ensure positioning stability, further stress is introduced to the warp and/or shute fibers.

FIG. 2 represents a flowchart which illustrates process flow steps of the cryogenic treatment of woven wire mesh material. As can be seen in FIG. 2, the first step in producing an improved wire cloth mesh is to manufacture or fabricate the mesh structure as seen in box 2.05. Typical, though not limiting, examples of such mesh structures are of the pre-crimped or normal mesh variety. Examples of such pre-crimped wire mesh structures would be double weave, scalping weave, double lock crimp, flat-top, triple shoot and intermediate crimp while examples of the normal wire mesh structures would be plain weave, twill weave, Hollander (Dutch) weave, Hollander twill weave and reverse Hollander weave.

Having once fabricated the desired mesh structure, the fabricated structure is thereafter immersed in or exposed to cryogenic material as described in box 2.06 and is cooled to −320° F. at a prescribed rate with a constant temperature maintained through the wire mesh as shown at box 2.10. As the mesh cools 2.10, molecules in the mesh slow and follow their natural tendency to bond together. The deep cryogenic phase box 2.20 begins when the wire mesh cools to −320° F. and typically lasts from 28 to 48 hours depending on the type of metal utilized in the construction of the fabricated mesh structure. This deep cryogenic phase must last long enough to achieve a structural balance throughout the wire mesh with deep cryogenic temperatures effecting a transformation of austenite to denser more refined martensite. During this transformation, other metallurgical modifications occur with particles formed through the precipitation of additional micro fine-carbonide fillers occupying remaining microvoid spaces. In austenitic stainless steel, there is some transformation to martensitic steel, which is harder than austenitic.

Having maintained the wire mesh for the requisite time period at the requisite temperature, the next process phase is a gradual warming phase of the mesh material 2.25. In the warming phase, as shown at box 2.25, the wire mesh is restored to ambient or room temperature. Warming occurs gradually with precise control of temperature changes, as exposure to erratic rising temperatures might disrupt the uniform and stabilized molecular structure of the wire mesh.

Once warmed to atmospheric temperature, the wire mesh is then introduced to an optional heat application phase shown at box 2.30. In the heat application phase 2.30, the wire mesh is elevated from ambient temperature to a temperature warm enough for sufficient duration, to remove brittleness in the wire mesh structure precipitated by the deep cryogenic phase 2.20. In most instances, the wire mesh would be cycled from room temperature to approximately 300° F. for an hour or more. Two or more cycles are typically required to insure any brittleness is removed from the wire mesh structures with such cycling occurring at a controlled gradual rate. Following the afore noted heat cycling 2.30 the fabricated wire mesh structure is restored to atmospheric ambient temperature 2.35 whereupon it is immediately available for application use.

Though the heat cycling process step 2.30 is typically employed to remove any brittleness in a wire mesh fabric, should brittleness be not deemed a significant concern for a particular application, this step may be eliminated and the material allowed to return to room temperature following cryogenic treatment and then employed in application use.

Modified processes of the foregoing are also possible. In one alternate process, the filaments or fibers may be cryogenically treated prior to weaving. The remaining steps of the process would remain similar.

An Alternative Treatment

While cryogenic treatment subjects metals to −320° F., a similar treatment, often referred to as shallow cryo treatment or shallow quenching, can be utilized to cool the mesh to approximately −120° F. Descending to this temperature can be accomplished using dry ice and a minimum investment in equipment. The results tend to be inferior to standard cryo treatment, and in some cases inefficient but may produce results superior to non-cryogenic treated screens.

What is claimed is:

1. A process to produce wire screen cloth to maximize screen life, which process comprises:
weaving wire screen cloth having parallel warp filaments and parallel shute filaments so that a plurality of openings are formed;
cooling said woven screen wire screen cloth at a controlled, prescribed rate to a temperature of, or below, minus 320° F. while maintaining temperature consistency throughout said parallel warp and shute filaments during said cooling;
maintaining said cooled cloth for a duration necessary to effectuate transformation of austenite crystals within said parallel warp and shute filaments to martensite crystals; and
warming said woven screen wire screen cloth to an ambient temperature at a controlled, prescribed rate to ensure non-disruption of the uniform and stabilized molecular structure of said woven screen wire screen cloth.

2. A process to produce wire screen cloth as set forth in claim 1 including the additional steps of heating said warmed woven screen wire screen cloth to a temperature necessary to eliminate brittleness of said parallel and shute filaments precipitated by said cooling, maintaining and warming process steps.

3. The process of claim 2 wherein said woven wire screen cloth is repeatedly heated to a temperature of or beyond 300° F., to eliminate brittleness of said parallel and shute filaments precipitated by said cooling, maintaining and warming process steps.

4. The process of claim 2 including the additional step of manufacturing a screen assembly from said cloth prior to said cooling.

5. The process of claim 1 including the additional step of calendaring the woven cloth prior to cooling.

6. The process of claim 1 including the additional step of calendaring the woven screen cloth after cooling, maintaining and warming said woven screen cloth.

7. The process of claim 1 including the additional step of calendaring the screen cloth after warming to ambient temperature.

8. The process of claim 1 including the additional step of cutting said screen cloth into pieces prior to said step of cooling.

9. A process to produce wire screen cloth to maximize screen life, which process comprises:
cooling filaments at a controlled, prescribed rate to a temperature of, or below, minus 320° F. while maintaining temperature consistency throughout said filaments during said cooling;
maintaining said filaments for a duration necessary to effectuate transformation of austenite crystals within said filaments;
warming said filaments to an ambient temperature at a controlled, prescribed rate to ensure non-disruption of the uniform and stabilized molecular structure of said filaments; and
weaving said filaments into wire screen cloth having parallel warp filaments and parallel shute filaments.

10. A process to produce wire screen cloth as set forth in claim 9 including the additional steps of heating said warmed filaments to a temperature necessary to eliminate brittleness of said filaments precipitated by said cooling, maintaining, and warming process steps.

11. A process to produce wire screen cloth as set forth in claim 9 wherein said warmed filaments are thereafter repeatedly heated to a temperature of or greater than 300° F., to eliminate brittleness of said filaments.

12. A process to produce wire screen cloth as set forth in claim 9 wherein said woven wire screen cloth is repeatedly heated to a temperature of greater than 300° F., to eliminate brittleness of said screen cloth.

13. A process to produce wire screen cloth as set forth in claim 9 including the step of calendaring prior to weaving.

14. A woven wire screen cloth which comprises:
a plurality of parallel warp filaments crossed by a plurality of parallel shute filaments wherein said filaments have been cooled at a controlled, prescribed rate to a temperature of, or below, minus 320° F. while maintaining temperature consistency throughout said filaments during said cooling, said filaments have been maintained for a duration necessary to effectuate transformation of austenite crystals within said filaments to martensite crystals, and said filaments have been warmed to an ambient temperature at a controlled, prescribed rate to ensure non-disruption of the uniform and stabilized molecular structure of said filaments.
